(19) United States
(12) Patent Application Publication
(10) Pub. No.: US 2004/0176087 A1
(43) Pub. Date: Sep. 9, 2004

(54) METHOD FOR UPDATING CODE STORED IN A MEMORY OF A PORTABLE DEVICE

(76) Inventor: Swee-Koon Fam, Sandiago, CA (US)

Correspondence Address: NAIPO (NORTH AMERICA INTERNATIONAL PATENT OFFICE), P.O. BOX 506, MERRIFIELD, VA, 22116, US

(21) Appl. No.: 10/248,987

(22) Filed: Mar. 7, 2003

(51) Int. Cl. H04M 3/00

(52) U.S. Cl. 455/419; 455/418

(57) ABSTRACT

A method for updating code stored in a memory of a portable device, such as a mobile phone or PDA, includes providing a plurality of code modules each having at least a target image reference (TIR) tag that uniquely identifies operational subunits of the code module, and providing a target image of operational code in the memory of the target device. The target image includes subunits and appended TIR tags uniquely identifying the subunits. The method further includes locating the TIR tag in the target image corresponding to an updated subunit to be loaded in the image, and loading the updated subunit into the memory of the target device at the location determined. The TIR tags allow for only updated subunits to be loaded into the memory of the device, reducing time and processing required and further reducing susceptibility to errors.

### BACKGROUND OF INVENTION

1. Field of the Invention

The present invention relates to a digital electronics, and more specifically, to a method for updating a memory of a portable device with operational program code using a computer system.

2. Description of the Prior Art

Typical embedded system images, such as those representing program code for controlling mobile phones or other handheld digital devices, comprise one or more modules compiled and binded into a single operational image. Modules include subroutines, parameters, data, and other code for operation of the device and can be referred to as the operating systems of a device.

During a build stage, modules are binded into a seamless target image by build tools run on a computer system. The target image is then loaded into a target device in a single step as one large file. No error can be tolerated during the loading process as any error usually results in the loading operation being aborted and requiring restarting.

Conventionally, the target image is built on a designated build computer. As the target image is low-level code it is inherently difficult to validate, and can usually only be checked by rigid configuration management and quality assurance (QA) procedures. Before a target image is loaded into a device, configuration management personnel check build logs and the build image itself to verify build quality, which is dependent on many factors including human error. However, these configuration management processes do not provide a functional check of the build, instead relying on a statistical approach. A functional check is provided by QA personnel after the target image has been loaded into a target device. The QA personnel perform many operational tests including operation and system tests, field tests, and third party certificate tests. Overall, testing a build of a target image is time consuming and not to be repeated unless completely necessary.

After a build is tested, service providers or operators are then responsible for loading the target image into a multitude of devices. For instance, when updating or initially loading mobile phone operating software, a service provider uses a computer system to execute a procedure to load a target image of the mobile phone operating software into subscriber mobile phones. As the target image is a single large file, there are no intermediate progress-verifying steps that can be easily performed by the service provider. As a result, the service provider usually only becomes aware of a specific build or load error after a subscriber mobile phone has had a failure.

In addition, service providers must support new models of mobile phones, some requiring new software altogether and others only requiring updated existing software, and further must support existing models of mobile phones through bug fixes and addition of new features. A complete target image file for each model of phone then becomes inefficient and prone to error, and a library of target image files becomes difficult to manage.

The typical prior art system builds and loads an entire target image into a device, when a single subunit of module code is modified or update. That is, all modules are binded into a single target image and loaded into the device, simply overwriting the existing software. Aside from being inefficient, rebuilding and rewriting unmodified subunits leads to unexpected sources of error, such as errors in previously error-free modules. In other words, the prior art system is inflexible and susceptible to error.

Thus, an improved system of updating low-level code for digital devices is required.

### SUMMARY OF INVENTION

It is therefore a primary objective of the present invention to provide an efficient and error-reducing method of updating a low-level code in a memory of a device to solve the abovementioned problems.

Briefly summarized, a method according to the present invention includes providing a plurality of code modules each having at least a target image reference (TIR) tag that uniquely identifies operational subunits of the code module, and providing a target image of operational code in the memory of the target device. The target image comprises subunits and appended TIR tags uniquely identifying the subunits. The method further includes locating the TIR tag in the target image corresponding to an updated subunit to be loaded in the image, and loading the updated subunit into the memory of the target device at the location determined.

According to the present invention, the method can further relocate a portion of the target image in the memory to accommodate an updated subunit before loading the updated subunit into the memory.

According to the present invention, the method can further test the updated subunit for errors before or after loading the subunit into the memory of the target device, and perform error-correcting actions if an error is found.

It is an advantage of the present invention that the TIR tags allow that only updated subunits need be loaded into the memory of the target device, reducing time and processing required and further reducing susceptibility to errors.

It is a further advantage of the present invention that the entire target image need only be initially loaded into the memory once, further updates being performed in a modular way.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a system for updating operational code in a mobile phone memory using a computer according to the present invention.

FIG. 2 is a flowchart of a method for updating code in a memory of a device according to the present invention.

### DETAILED DESCRIPTION

The present invention method is described in the following as updating a mobile phone memory, however, the method is also applicable to other memory using devices such as personal digital assistants (PDAs) and the like.

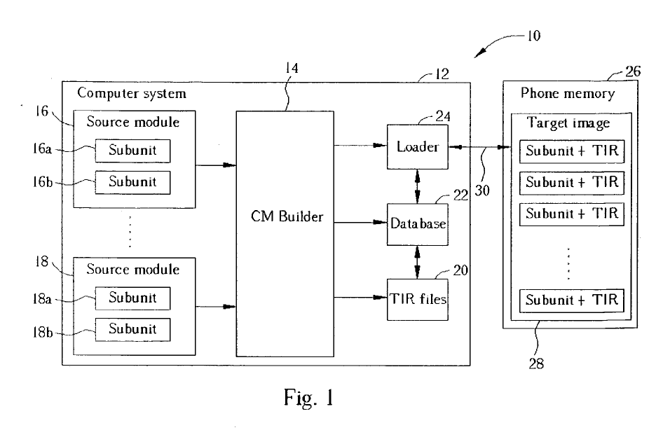

Please refer to FIG. 1 showing a system 10 for updating low-level code in a memory such as a memory 26 of a mobile phone or similar device. The system 10 includes a computer system 12 comprising a processor, random access memory, hard drive, and user interface in a combination well known in the art. The computer system 12 is capable of executing a configuration manager (CM) builder 14 to bind subunits 16a, 16b, 18a, and 18b of respective source code object modules 16 and 18. Two modules 16 and 18 are illustrated for clarity, and in practical application a larger number of modules is used. The computer 12 includes a plurality of corresponding target image reference (TIR) files 20, one for each subunit 16a, 16b, 18a, and 18b. The plurality of TIR files 20 stores information regarding the location of each subunit within a target image 28 in the memory 26, descriptions of each subunit”s operation, and a version number of each subunit. The TIR files 20 and the subunits 16a, 16b, 18a, and 18b of the respective source code modules 16 and 18 are cross-referenced though a database 22, or other such referencing mechanism. The computer 12 further comprises a loader 24 for loading subunits, individually or as part of a larger image, into the memory 26 to form the target image 28. The loader 24 references the database 22 and the target image 28 to perform the loading operation. The computer system 12 and mobile phone memory 26 are connected for data communication by a connecting cable 30, or alternatively, by radio or infrared transmitter and receiver pairs.

The object module files 16 and 18 include relocatable code references such as those shown in Table 1. The CM builder 14 uses this information to bind subunits 16a, 16b, 18a, and 18b of the modules 16 and 18 into loadable images. The size of the loadable image, that is, how many subunits it comprises depends on what is required to be loaded into the memory 26. For example, when the memory 26 is empty, the CM builder 14 generates an image that includes all subunits 16a, 16b, 18a, and 18b of all modules 16 and 18. However, according to the present invention, the CM builder 14 is capable of binding one or more subunits into a loadable image file, and the loader 24 is capable of loading that image into the phone memory 26 so as to only replace the corresponding part of the target image 28. As the CM builder 14 generates the loadable image file, information of the subunits such as that in Table 1 is parsed into corresponding TIR files 20. Additionally, corresponding TIR tags, one for each subunit, are generated to reference the TIR files through the database 22. Before the loader 24 loads a subunit into the memory as part of the target image 28, the CM builder 14 appends the corresponding TIR tag so that the target image 28 includes subunits of operational code and corresponding TIR tags as illustrated in FIG. 1. Each TIR tag is unique to each subunit and allows each subunit to be quickly located within the target image 28. As an alternative to streamline operations, version numbers of the subunits can be stored in the TIR tags themselves. Additionally, when the subunits and appended TIR tags are loaded into the target image 28 by the loader 24, it may be necessary to relocate portions of the target image 28. This relocation is accomplished by the loader 24 referencing the TIR tags of the subunits in the target image 28 and also the plurality of TIR files 20. When subunits of the target image 28 are relocated to accommodate a new or larger subunit, the contents of those relocated subunits is modified and updated by the loader 24. Furthermore, the CM builder 14 updates the corresponding TIR files.

TABLE I

File header and optional header information
Table of section headers
Data indaxed by section header
Relocation information
Line numbers
Symbol table
String table

The CM builder 14 can examine a loadable subunit before sending the subunit to the memory 28, providing proactive error detection. The loader 24 is capable of examining a subunit loaded into the memory 26 and verify that the loading process was executed correctly. The CM builder 14 and the loader 24 are further capable of outputting reports indicating their statuses and the success or failure of their operations.

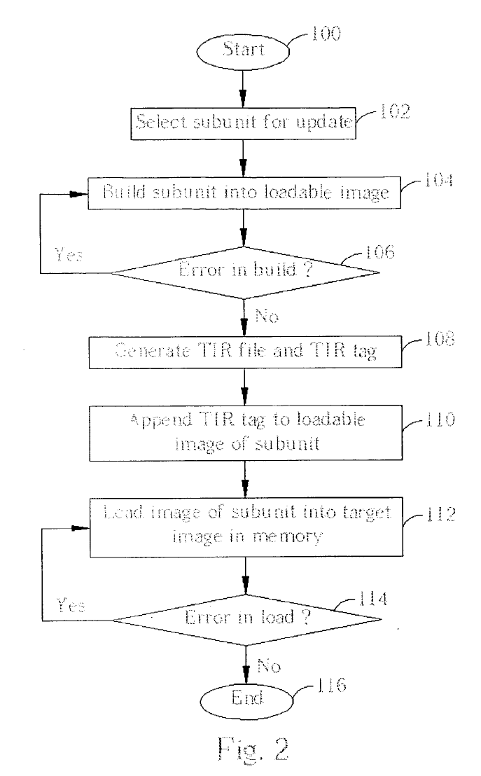

Please refer to FIG. 2 illustrating a flowchart of a method according to the present invention. The steps of the flowchart of FIG. 2 are as follows:

Step 100: Start;

Step 102: An operator selects a subunit of a module, for example subunit 16b in FIG. 1, which is required to be updated. The subunit 16b may need to be updated for a variety of reasons such as implementing a new feature or fixing a programming error;

Step 104: The CM builder 14 builds the subunit 16b into a loadable image so that it is functional in the memory 26 of the mobile phone. That is, a processor of the mobile phone can execute and operate on the loadable image;

Step 106: The CM builder 14 checks the loadable image of the subunit 16b for errors. If there is an error in the build return to step 104, if there is no error go to step 108;

Step 108: The CM builder 14 generates a TIR file, which includes a location, description, and version number of the subunit 16b. The TIR file is stored on the computer system 12 as part of the plurality of TIR files 20. The CM builder 14 further generates a TIR tag corresponding to the TIR file and stores the TIR tag in the database 22;

Step 110: The CM builder 14 appends the TIR tag to the image of the subunit 16b thereby linking it to the corresponding TIR file;

Step 112: The loader 24 loads the image of the subunit 16b including the appended TIR tag into the location in the target image 28 in the memory 28 corresponding to the TIR tag. That is, the loader 24 locates the TIR tag in the target image 28 and overwrites the corresponding subunit code with the updated subunit 16b image. If required, the loader 24 relocates other portions of the target image 28;

Step 114: The loader 24 checks for errors in the loaded image of the subunit 16b, verifying the success of the loading process. If an error is detected return to step 112, if no error is detected go on to step 116;

Step 116: End.

The above procedure can be performed for more than one subunit, either in a succession of executions of the procedure, or by simultaneously handling more that one subunit at a time. If required, more than one subunit of a given code module can have the same TIR tag, making these subunits inseparable and effectively a single subunit according to the present invention method. Errors occurring before or after the loader 24 loads the subunit into the target image 28 can alternatively be handled by halting the building or loading procedure or by alerting the operator for intervention. Furthermore, during execution of the above procedure, the CM builder 14 and loader 24 generate reports for use by the operator in evaluating the success of the respective operations.

In practical application, the present invention can be realized with computer hardware such as a processor, memory, mass storage device, and user interface and in computer program code.

In contrast to the prior art, the present invention method of loading only the specific parts of a target memory image to a device offers improvements of speed, cost, and reliability. By eliminating redundant loading of non-updated code update time and cost are reduced, as well and the probability of error.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for updating a memory of a target device with at least a subunit of operational code using a computer, the method comprising:
providing a plurality of code modules, each code module having at least a target image reference (TIR) tag that uniquely identifies operational subunits of the code module;
providing a target image of operational code in the memory of the target device, the target image comprising operational subunits and appended TIR tags uniquely identifying the subunits;
locating the TIR tag in the target image corresponding to an updated subunit to be loaded in the image; and
loading the updated subunit into the memory of the target device at the location determined.

2. The method of claim 1 further comprising relocating a portion of the target image in the memory to accommodate the updated subunit before loading the updated subunit into the memory.

3. The method of claim 1 further comprising testing the updated subunit for errors before loading the subunit into the memory of the target device, and performing a first predetermined action if an error is found.

4. The method of claim 1 further comprising testing the updated subunit for errors after loading the subunit into the memory of the target device, and performing a second predetermined action if an error is found.

5. The method of claim 1 wherein each TIR tag further identifies a version number of each subunit.

6. The method of claim 1 wherein the memory of the target device is a flash memory.

7. The method of claim 1 further comprising storing a database on the computer, the database comprising relations between the operational subunits of the code modules and the TIR tags.

8. The method of claim 7 further comprising generating a plurality of TIR files, each TIR file describing the operational code in each subunit, a version number of each subunit, and a location of the subunit in the target image; each TIR file corresponding to a TIR tag that identifies each subunit, the database further comprising relations between the TIR files and the TIR tags.

9. A computer system for performing the method of claim 1.

10. A method for storing subunits of operational code in a memory of a target device using a computer, the method comprising:
providing a plurality of code modules in the computer, each code module comprising at least a subunit of code operational on the target device;
appending a unique target image reference (TIR) tag to each subunit, each TIR tag uniquely identifying each subunit;
storing each subunit and each appended TIR tag in the memory as a target memory image, the TIR tags identifying the locations of the operational subunits within the memory; and
storing a database on the computer, the database comprising relations between the operational subunits of the code modules and the TIR tags, wherein when a subunit is required to be updated the database is referenced to determine the location of the subunit in the memory.

11. The method of claim 10 further comprising generating a plurality of TIR files, each TIR file describing the operational code in each subunit, a version number of each subunit, and a location of the subunit in the target image; each TIR file corresponding to a TIR tag that identifies each subunit, the database further comprising relations between the TIR files and the TIR tags.

12. The method of claim 10 wherein each TIR tag further identifies a version number of each subunit.

13. The method of claim 10 wherein the memory of the target device is a flash memory.

14. A computer system for performing the method of claim 10.
